(19) United States
(12) Patent Application Publication
(10) Pub. No.: US 2019/0152003 A1
(43) Pub. Date: May 23, 2019

(54) Strengthening Repair Wrap

(71) Applicant: Scott Gungel, Littleton, CO (US)

(72) Inventor: Scott Gungel, Littleton, CO (US)

(21) Appl. No.: 16/196,991

(22) Filed: Nov. 20, 2018

Related U.S. Application Data
(60) Provisional application No. 62/589,565, filed on Nov. 22, 2017.

(51) Int. Cl. B23P 6/04; F16L 55/168

(52) U.S. Cl. CPC B23P 6/04; B29C 73/10; F16L 55/1683

(57) ABSTRACT

A repair wrap for repairing or strengthening an inanimate object. The repair wrap includes a piece of annealed aluminum or aluminum with a paper covered adhesive backer. The aluminum is configured to be wrapped around a portion of an inanimate object to form a shell and strengthen a damaged area or joint, or it can be placed on portions of an inanimate object to form a shell over holes.

Properties of Repair Wrap:

1. Applied directly to the desired area without intervening layers;

2. Can be applied easily, without training;

3. Water resistant and rustproof;

4. Permanently affixed, it is not meant to come off easily;

5. High density to create desired sealing properties and strength of the wrap;

6. Comes in sheets of differing sizes that can be cut with ordinary scissors to desired size; and

7. Strong adhesive bonds firmly in temperatures ranging from −40 to 150 degrees Fahrenheit.

FIG. 2 shows an example of an inanimate object with a hole that may be repaired by the repair wrap.

FIG. 3 shows an example of an inanimate object that is broken in two pieces that may be repaired by the repair wrap.

FIG. 4 shows the method of wrapping the repair wrap about the inanimate object, the repair wrap can be wrapped around the portion of the first inanimate object and the portion of the second inanimate object that are proximate one another such that the portion of the first inanimate object and the portion of the second inanimate object that are proximate one another are secured to one another. The repair wrap can also be wrapped directly on the surface of the portion of the inanimate object to cover holes. This method of repair enables types of repairs that are not possible using traditional tapes or other solutions. The wrapping technique may depend on the type of repair.

For example, for high impact repairs you would need to wrap the broken area multiple times to achieve the original strength of the item. Examples of high impact items are things like hammers or other tools that must withstand the load of a striking force associated with repeated impacts and rebound.

For leak sealing repairs a different wrapping method may be desired. For example, the surface area is meant to be covered completely and it is not of a high impact nature. For this, the object being repaired would not require multiple layers of wrap, but instead one thin layer to effectively cover the hole and seal the edges to create a water-tight seal.

FIG. 5 shows a completed repair that has both high impact strength as well as water retention properties. As soon as the repair wrap has been adhered to the surface of an object the repair is complete. There are no glues or chemicals that take time to dry and the aluminum patch is safe for humans to touch. The high performing adhesive holds firmly to create permanent repairs but with diligence it may be removed in the future if required. The smooth properties of the aluminum strengthening repair wrap allow for easy painting, and the rustproof characteristics of aluminum enable extreme resistance to harsh climates.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### DESCRIPTION

### Background of the Invention

When faced with the task of repairing a broken item, such as the handle of a broom for example, a person generally has the choice of attempting to repair the item, or discarding the item and purchasing a replacement.

As an example, should an individual choose to purchase a new item it may be costly and take an extended time to procure a suitable item. In some instances it may be impossible to find a suitable replacement. In such an instance, the user may have to strike a compromise and attempt to find a substitute that may or may not be fully satisfactory for its intended use.

As an alternative to purchasing a replacement an individual may attempt to repair the item, and thereby avoid the aforementioned difficulties. However, depending upon the item to be repaired and the type of damage, some breaks or other damage may not lend themselves to a wide range of remedies. Thus, an individual may attempt to repair the broken item but find nothing suitable to restore the original strength of the broken item.

Thus, there is a need for a repair material that allows an individual to repair, rather than replace an item. More so, there is a great need for a repair material that can provide and restore a rigid structure to the damaged item. Moreover, there is a desperate need for a repair material that is water-resistant and allows for quick and easy repairs that adhere directly to the object and repairs without drying or curing times.

### Brief Summary of Some Example Embodiments

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a repair wrap for repairing or strengthening an inanimate object. The repair wrap includes an annealed aluminum or aluminum sheet, whereon there is an adhesive backer on one side with a paper covering which is removed, and the adhesive side is placed on the inanimate objects and wrapped around the first and second portions of the inanimate object in direct contact with the inanimate object; thereby forming a hardened metal shell around the first and second portions of the inanimate object.

Another example embodiment includes a repair wrap for repairing or strengthening an inanimate object. The repair wrap includes an annealed aluminum or aluminum sheet, whereon there is an adhesive backer on one side with a paper covering which is removed, and the adhesive side is placed on the inanimate object to cover the hole in the inanimate object in direct contact with the inanimate object; thereby forming a water-tight hardened metal shell over the portion of the hole in the inanimate object.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a repair wrap;

FIG. 2 illustrates a broken inanimate object with a hole on which a repair wrap can be used;

FIG. 3 illustrates a broken inanimate object on which a repair wrap can be used;

FIG. 4 illustrates an example of a repair wrap being applied to an inanimate object;

FIG. 5 illustrates an inanimate object with the repair wrap forming an instant hardened shell on the inanimate object.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

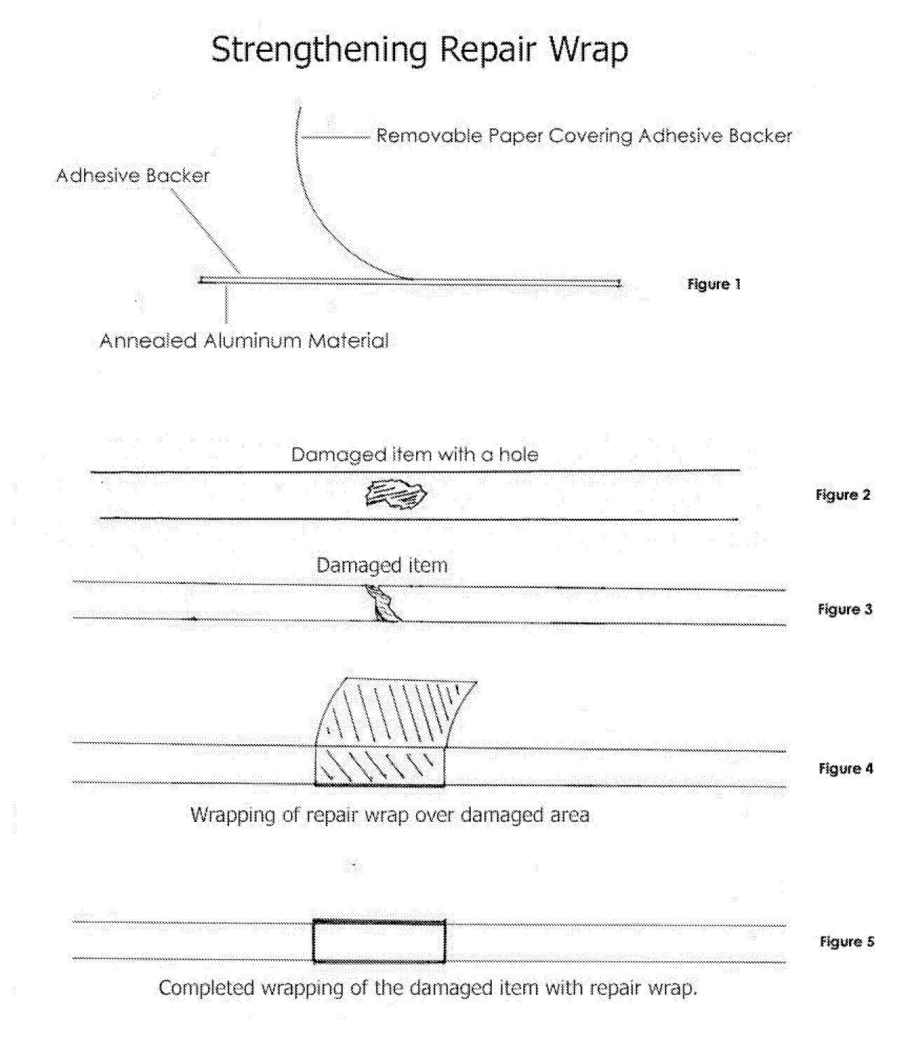

FIG. 1 illustrates an example of the repair wrap. The repair wrap can be employed in a wide variety of applications. For example, the repair wrap may be used to repair, temporarily or permanently, broken items. I.e., if an object has been broken, the two ends of the break can be positioned proximate to one another and the repair wrap can be applied, securing the two ends of the break in their respective position. Additionally or alternatively, the repair wrap may be used to join two or more elements together, even if the elements were not previously broken apart from each other, may be used to patch holes, may be used to strengthen an object or used for any other desired purpose.

In general; the repair wrap may be employed to affect repairs of broken items that may be rigid, or relatively flexible. As used herein, the term ‘repair’ is intended to be broadly construed and includes, but is not limited to: the joining of two pieces of an item that have partially or completely broken apart from each other and/or the covering of a hole, crack or fracture in an item or restore or straighten a bent or folded item.

General areas of application include industry, aviation, home and garden, sporting goods, recreation, landscaping, automotive, military and agriculture. For example, the repair wrap may be used in connection with a variety of different materials. Such materials include, but are not limited to, wood, metal, glass, plastic, rubber, composites, fiberglass, ceramic, concrete, and combinations of any of the foregoing. E.g., the repair wrap may be used to repair, temporarily or permanently, items such as garden tool handles, ski poles, hiking poles, golf clubs, baseball and softball bats, fishing rods, piping, tubing, sprinkler piping, tent poles, hoses, carbon bike frame tubes, oars, paddles, posts, rails, luggage racks, and furniture. In addition to use in the repair; or joining, of elements of the aforementioned inanimate objects, various specialized applications of the repair wrap are also possible.

What is claimed is:

1. A repair system, the repair system comprising: an inanimate object having first and second portions and a broken portion positioned between the first and second portions, an annealed aluminum or aluminum sheet, whereon there is an adhesive backer on one side with a paper covering which is removed, and the adhesive side is placed on the inanimate objects and wrapped around the first and second portions of the inanimate object in direct contact with the inanimate object; thereby forming a hardened metal shell around the first and second portions of the inanimate object.

2. A repair system, the repair system comprising: an inanimate object having one portion and a hole within this portion; an annealed aluminum or aluminum sheet, whereon there is an adhesive backer on one side with a paper covering which is removed, and the adhesive side is placed on the inanimate object to cover the hole in the
inanimate object in direct contact with the inanimate object; thereby forming a water-tight hardened metal shell over the portion of the hole in the inanimate object.
